(19) United States
(12) Patent Application Publication
(10) Pub. No.: US 2013/0230744 A1
(43) Pub. Date: Sep. 5, 2013

(54) ELECTRODE FOR MICROBIAL FUEL CELL AND MICROBIAL FUEL CELL USING THE SAME

(71) Applicants: Kazuhito Hashimoto, Tokyo (JP); Kazuya Watanabe, Tokyo (JP); Yong Zhao, Tokyo (JP)

(72) Inventors: Kazuhito Hashimoto, Tokyo (JP); Kazuya Watanabe, Tokyo (JP); Yong Zhao, Tokyo (JP)

(73) Assignee: Japan Science and Technology Agency, Saitama (JP)

(21) Appl. No.: 13/885,508

(22) PCT Filed: May 16, 2011
(86) PCT No.: PCT/JP2011/061199

§ 371 Date: May 15, 2013

(30) Foreign Application Priority Data
Nov. 18, 2010 (JP) 2010-257390

(51) Int. Cl. H01M 8/16; H01M 4/96

(52) U.S. Cl. CPC H01M 8/16; H01M 4/96
USPC 429/2; 429/523

(57) ABSTRACT

Provided is an electrode for a microbial fuel cell, which is capable of generating high-power electric current in the microbial fuel cell and the microbial fuel cell using the electrode. Specifically, the invention relates to an electrode (as an anode of a microbial fuel cell) for a microbial fuel cell which contains a carbon-containing electrode base and carbon nanowires formed across the whole or a part of the surface of the electrode base is provided. Consequently, the electrode surface area is significantly increased and the affinity between an electron conductive microorganism and the electrode is increased. The efficiency of charge transfer from the microorganism to the electrode can thus be dramatically increased.

### TECHNICAL FIELD

The present invention relates to an electrode to be used for a microbial fuel cell, and more specifically relates to an electrode comprising a carbon-containing electrode base that has a carbon nanowire structure on the surface, and a microbial fuel cell using the electrode.

### BACKGROUND ART

Microbial fuel cells are gaining attention as an alternative new electric power generation system to conventional fossil fuels.

A microbial fuel cell is an electric power generation system that converts chemical energy into electrical energy using the microbial capacity of bioactivity. Microbial fuel cells can use as fuel unused biomass such as organic waste water, sludge, and food residues. Hence, it can be used for sustainable electric power generation systems having the advantage of being able to degrade organic waste simultaneously with power generation. If a microorganism capable of using pollutants is used, environmental purification such as in the treatment of contaminated waste water is possible. Furthermore, a microorganism itself functions as a biocatalyst that removes electrons from an organic matter, so that it has the advantage of low-cost and extremely high energy conversion efficiency without requiring gas exchange processes such as those for conventional chemical fuel cells (e.g., hydrogen fuel cells).

Meanwhile, current microbial fuel cells have a significant problem such that the output current density is low, and thus they require further improvement in order to achieve practical power generation capacity. In general, the increase of output current density in a microbial fuel cell depends on the efficiency of charge transfer from a microorganism to an electrode. Moreover, the charge transfer efficiency is influenced by surface area and properties of the electrode.

To address the above problems, for example, an attempt has been made to increase output current density by adding an electron mediator (electron carrier) such as HNQ (2-hydroxy-1,4-naphthoquinone) to an electrolytic vessel so as to improve the efficiency of electron transfer from a microorganism to an electrode (Non-patent Literature 1). However, electron mediators are problematic in that they are generally expensive and many of them are toxic to human bodies or the like. Furthermore, the thus obtained amount of electric current generated is insufficient for practical use.

Patent Literature 1 discloses a microbial fuel cell produced using an electron-accumulating microbial variant and coating or dipping carbon fiber as an electrode base with or in polyaniline. The microbial fuel cell is produced so as to be able to efficiently and directly extract electrons from the microorganism by increasing the surface area of the electrode with the use of carbon fiber, and by being coated with polyaniline as an electron mediator. However, the microbial fuel cell is problematic in that a thin layer coating film of polyaniline is merely formed on the surface of carbon fiber and there is room for improvement in enhancement of electron transfer between the microorganism and the electrode.

### PRIOR ART LITERATURE

### Patent Literature

Patent Literature 1: JP Patent Publication (Kokai) No. 2007-324005 A

### Non-Patent Literature

Non-patent Literature 1: Rhoads A et al., 2005, Environ Sci Technol., 39: 4666-4671.

### SUMMARY OF THE INVENTION

### Problems to Be Solved by the Invention

In view of the above problems, an object of the present invention is to develop and provide an electrode for a microbial fuel cell capable of generating high-power electric current as a result of further increasing the efficiency of charge transfer from a microorganism to an electrode in the microbial fuel cell. Another object of the present invention is to provide a high-power microbial fuel cell using the electrode.

### Means for Solving the Problem

As a result of intensive studies to address the above problems, the present inventors have found that the efficiency of charge transfer from a microorganism to an electrode is enhanced 10-fold to 100-fold over that of a conventional electrode for a microbial fuel cell by forming a carbon nanowire structure on the surface of an electrode base containing carbon so as to increase the surface area of the electrode. Specifically, the present invention is based on this finding and provides the following (1) to (8).

(1) An electrode for a microbial fuel cell, comprising an electrode base that contains carbon and carbon nanowires that are formed across the whole or a part of the surface of the electrode base, wherein the electrode for a microbial fuel cell has a fibrous structure or a porous structure containing gaps and/or pores, and the length and/or the width of a single gap and the diameter of a single pore each range from 6 μm to 20 μm.
(2) The electrode according to (1), wherein all or some carbon nanowires form a nanowire network.
(3) The electrode according to (1) or (2), wherein the electrode base comprises graphite.
(4) The electrode according to any one of (1) to (3), wherein the gap or the pore contains an electron donor microorganism therein.
(5) A microbial fuel cell, using the electrode of any one of (1) to (4).
(6) The microbial fuel cell according to (5), comprising an anode and/or a cathode that comprises the electrode of any one of (1) to (4), an electrolyte solution, and an electrolytic vessel accommodating them, wherein the electrolyte solution in the electrolytic vessel further contains an electron donor microorganism comprising a single or multiple species and a nutritional substrate required for the metabolism of the microorganism.
(7) The microbial fuel cell according to (6), wherein the cathode is an air cathode having gas permeability and the electrolytic vessel has a single vessel structure composed of only an anode vessel.
(8) The microbial fuel cell according to (6) or (7), wherein the vessel in which the anode or the cathode is installed further contains a redox mediator compound, an electron mediator, and/or conductive fine particles therein.

This description includes part or all of the contents as disclosed in the description and/or drawings of Japanese Patent Application No. 2010-257390, which is a priority document of the present application.

### Effects of the Invention

The electrode for a microbial fuel cell of the present invention makes it possible to significantly increase the surface area of the electrode, and thus an electrode capable of generating high-power current density can be provided.

According to the microbial fuel cell of the present invention, output power can be drastically improved compared with conventional microbial fuel cells.

### BRIEF DESCRIPTION OF THE DRAWINGS

FIG. 1 (A) shows a scanning electron microscopic image of carbon nanowires formed on a graphite plate. As shown in FIG. 1 (A), the surface of the graphite plate is covered with nanowire-network-forming carbon nanowires each with a diameter of 40 nm or less. FIG. 1(B) shows the generated electric current obtained with the use of a GP or GP-CN anode in Example 2.

FIG. 2(A) shows a scanning electron microscopic image of graphite felt and FIG. 2(B) shows a scanning electron microscopic image of carbon nanowires formed on the surface of a single graphite fiber that forms graphite felt (In FIG. 2(B), carbon nanowires form a nanowire network). FIG. 2(C) shows an embodiment of the electrode for a microbial fuel cell of the present invention, in which carbon nanowires are formed on the surface of graphite felt.

FIG. 3 is a conceptual diagram showing an example of the microbial fuel cell of the present invention.

FIG. 4 shows the voltage (square plot) and the power density (circle plot) of a microbial fuel cell obtained with the use of graphite felt (GF) or graphite felt-carbon nanowire (GF-CN) anode electrodes in Example 3. “o” indicates the voltage of the GF electrode and “▪” indicates the voltage of the GF-CN electrode. “o” indicates the power density of the GF electrode. “” indicates the power density of the GF-CN electrode.

FIG. 5(A) shows the voltage (square plot) and the power density (circle plot) of a microbial fuel cell obtained with the use of the GF or GF-CN anode electrode in Example 4. “□” indicates the voltage of the GF electrode and “▪” indicates the voltage of the GF-CN electrode. “◯” indicates the power density of the GF electrode and “” indicates the power density of the GF-CN electrode. FIG. 5(B) shows a cyclic voltammogram obtained before addition of HQN to an electrolytic vessel in a microbial fuel cell in Example 4. FIG. 5(C) shows a cyclic voltammogram obtained after addition of HQN to an electrolytic vessel in a microbial fuel cell in Example 4. In FIG. 5(B) and FIG. 5(C), broken line (1) indicates the cyclic voltammogram in the case of the GF electrode and continuous line (2) indicates the cyclic voltammogram in the case of the GF-CN electrode.

FIG. 6 shows changes over time in Pmax level of a GF or GF-CN anode electrode in a microbial fuel cell of Example 5. In FIG. 6, (1) shows the results for the GF electrode, (2) shows the results for the GF-CN electrode, and (3) shows the results for the GF-PAN electrode.

FIG. 7 is a conceptual diagram showing, when the electrode for a microbial fuel cell of the present invention has a fibrous structure, the gap size of each fiber configuring the electrode and the size of an electron donor microorganism (a). Carbon nanowires are formed on the surface of each fiber (b) (not shown).

### EMBODIMENTS FOR CARRYING OUT THE INVENTION

### 1. Electrode for Microbial Fuel Cell

### 1-1. Summary

The 1^{st} embodiment of the present invention is an electrode for a microbial fuel cell. The term “electrode for a microbial fuel cell” of the present invention refers to an electrode to be used for a microbial fuel cell.

The term “microbial fuel cell (MFC)” refers to an apparatus by which electrons generated through the metabolism of an electron donor microorganism as a biocatalyst, such as respiration of the microorganism, are acquired or extracted, following which such electrons are transferred to an electrode for power generation. Such a microbial fuel cell and electron donor microorganism are described in detail in Chapter 2 “Microbial fuel cell,” and thus the explanation therefor is omitted herein.

### 1-2. Configuration of Electrode for Microbial Fuel Cell

The electrode for a microbial fuel cell of the present invention is composed of an electrode base and carbon nanowires formed across the whole or a part of the surface of the electrode base. Hereinafter, the electrode base and carbon nanowires that configure the electrode for a microbial fuel cell of the present invention are specifically explained as follows.

### 1-2-1. Electrode Base

The term “electrode base” refers to an electronic conductive material that configures the main electrode body. The electrode base has, in principle, a connecting terminal for connection with a conductor that communicates between a main electrode body and an external circuit.

The material of the main electrode base body that configures the electrode for a microbial fuel cell of the present invention is an electronic conductive material containing carbon. Here, the term “carbon” refers to an electrically-conductive substance made of namely a carbon atom (C). Examples thereof include graphite, coal (e.g., activated carbon and charcoal), and carbon black. A preferable example thereof is graphite. The electrode base of the present invention may comprise, in addition to carbon, other electronic conductive materials such as metal (including an alloy) and an oxide thereof. For example, the electrode base may comprise titanium (Ti), vanadium (V), chrome (Cr), manganese (Mn), iron (Fe), cobalt (Co), nickel (Ni), molybdenum (Mo), ruthenium (Ru), rhodium (Rh), palladium (Pd), hafnium (Hf), tantalum (Ta), tungsten (W), rhenium (Re), osmium (Os), iridium (Ir), indium (In), tin (Sn), or alloys thereof, or oxides thereof.

The electrode base that configures the electrode for a microbial fuel cell of the present invention may be stiff so that it can maintain the shape of the electrode. For example, when an electrode is composed of graphite, it is shaped so that it has a thickness that is the same as or greater than a given thickness, and thus it becomes possible for such electrode to maintain a certain shape. In this case, the electrode base itself also functions as a support for the electrode.

Alternatively, the above electrode base may not be stiff by itself, such as powdered microparticles (e.g., carbon black), and extremely thin films (e.g., coat). In this case, the electrode base itself cannot maintain the shape as an electrode, so that it should be formed on the surface of a support comprising another substance for providing an electrode shape. The material of such a “support comprising another substance” is not particularly limited, as long as it is a stiff insulator and is preferably a water-resistant substance. Examples of such material include glass, plastic, synthetic rubber, ceramics, and paper treated to have water resistance, and plant pieces. Examples of a method for carrying an electrode base on the surface of a support include coating (including immersion), spraying, pasting, and evaporation. These procedures may be performed on the basis of methods known in the art. An example of such a method involves mixing carbon black with an appropriate adhesive and a solvent thereof, so as to fix the resultant onto the glass wool surface by immersion. The thickness of an electrode base to be formed on the surface of a support is not particularly limited, as long as a carbon nanowire structure to be described later can be formed on the surface and electrons received from an electron donor microorganism can be transferred to a conductor connected to the electrode base. Specifically, the thickness may be appropriately determined depending on electrode size, electrode production cost, and the environment within a vessel into which an electrode is applied, for example.

### 1-2-2. Carbon Nanowire

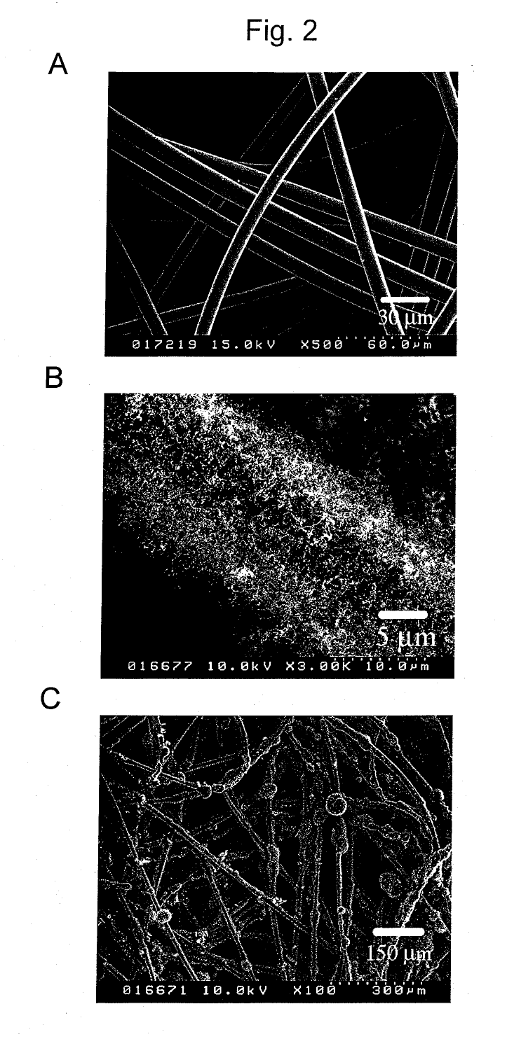

The electrode for a microbial fuel cell of the present invention has carbon nanowires across the whole or a part of the surface of the above electrode base. The term “carbon nanowire(s)” refers to a linear nanostructure composed of carbon, which is particularly formed artificially. Specifically, such carbon nanowires have a linear nanostructure as shown in FIG. 2(B). In the present invention carbon nanotubes or carbon nanohorns that are formed because of the specific structure of grapheme are also examples of the carbon nanowires.

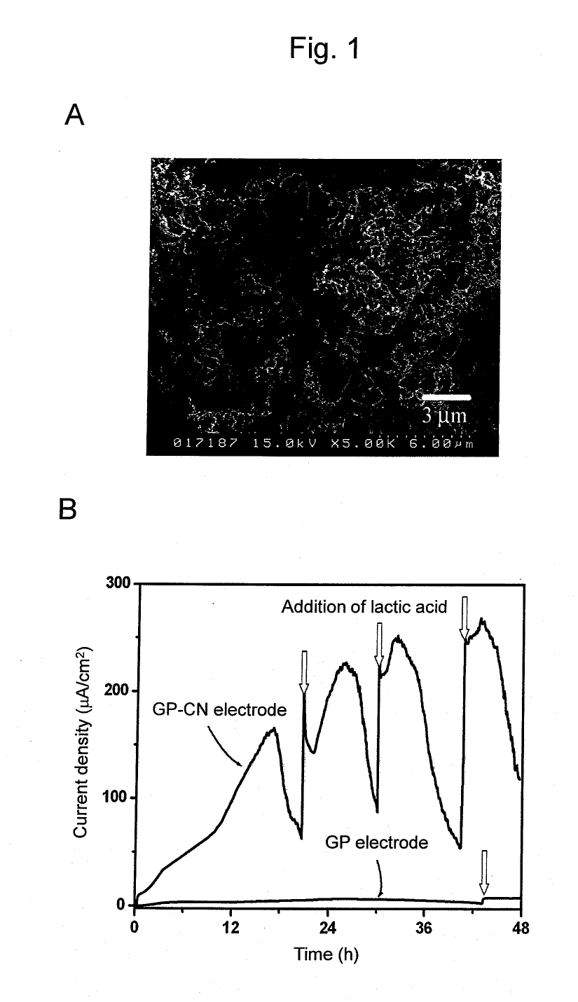

Carbon nanowires in the electrode for a microbial fuel cell of this embodiment include two-dimensional nanowires that are composed of a plurality of independent nanowires spreading over the same surface and a nanowire network, as modes of the structure. In the Description, the term “nanowire network” refers to a 3-dimensional meshwork structure that is formed when individual carbon nanowires adjacent to each other on the same surface and/or different surfaces come into contact with each other and/or grow in a vertical and/or horizontal direction, so as to be fused to each other. For example, structures shown in FIG. 1(A) and FIG. 2(B) fall under such definitions. The nanowire network generally has numerous pores (each about 10 nm to about 1 μm). Microorganisms cannot enter pores of such size, while electron transfer mediators such as redox mediator compounds, electron mediators, and/or conductive fine particles can enter the same. The formation of such a nanowire structure on the surface of an electrode base can make it possible to dramatically increase the surface area of the electrode of the present invention. In addition, these “electron transfer mediators,” “redox mediator compounds,” “electron mediators,” and “conductive fine particles” are described in detail in Chapter 2, “Microbial fuel cell,” and thus the explanation thereof is omitted herein.

The carbon nanowires of the present invention can be prepared based on methods known in the art. However, the formation of carbon nanowires on the surface of a carbon fiber electrode base such as graphite felt under conventional chemical vapor deposition conditions may fail because of the hydrophobicity of the surface. This problem can be solved by performing pre-treatment using a mixture prepared by mixing ethanol and water at a ratio ranging from 1:3 to 3:1, and more preferably at a ratio of 1:1, so as to hydrophilize the surface of the carbon fiber electrode base. A method for preparing the carbon nanowires is specifically explained in 1-5, “Preparation of electrode for microbial fuel cell,” which is described later.

### 1-3. Structure of Electrode for Microbial Fuel Cell

The structure of the electrode of the present invention is not particularly limited but the electrode preferably has a fibrous structure or a porous structure. When the electrode has a fibrous structure or a porous structure, many irregularities are formed on the electrode surface, so that the surface area of the electrode having such structure can be increased to a level higher than those of electrodes having plane surfaces, such as flat-plate electrodes. As a result, the rate of electron transfer from an electron donor microorganism or an electron transfer mediator to the electrode (described in detail in Chapter 2 Microbial fuel cell) is improved, and thus electrons generated from the electron donor microorganism can be efficiently transferred to the electrode. The electrode structure of the present invention is determined depending on the structure of the electrode base when the electrode base itself is stiff. When the electrode base itself is not stiff, the electrode structure of the present invention is determined depending on the structure of a support, as described above.

The term “fibrous structure” in the Description refers to a structure in which a plurality of thin linear electrode units are assembled. Specifically, the term “fibrous structure” refers to a structure in which a plurality of electrode units are assembled as shown in FIG. 2(C), wherein carbon nanowires shown in FIG. 2(B) are formed on the graphite fiber surface having a linear structure as shown in FIG. 2(A). Examples of an electrode having such a fibrous structure include a carbon fiber electrode prepared by forming carbon nanowires on the surface of carbon fiber (e.g., graphite felt and carbon wool) as an electrode base, a carbon/metal fiber electrode prepared by carrying carbon black as an electrode base on the metal wool surface and then forming carbon nanowires on the carbon black, a carbon/glass fiber electrode prepared by carrying carbon black on glass wool surface and then further forming carbon nanowires on the carbon black, a carbon/cellulose fiber electrode prepared by carrying carbon black on the paper surface, and then further forming carbon nanowires on the carbon black, a carbon/fibrous protein electrode prepared by carrying carbon black on silk felt, and then further forming carbon nanowires on the carbon black, and a carbon/plastic fiber electrode prepared by carrying carbon black on plastic wool and then further forming carbon nanowires by the carbon black. A preferable example thereof is a carbon fiber electrode prepared by forming carbon nanowires on the surface of carbon fiber such as graphite felt and carbon wool as an electrode base.

The term “porous structure” in this Description refers to a structure having many pores on the surface or the interior thereof. Examples of an electrode having such a porous structure include an electrode prepared by forming carbon nanowires on the surface of an electrode base made of porous carbon and an electrode prepared by carrying carbon black as an electrode base on the surface of porous ceramic, porous plastic, plant pieces (e.g., wood), animal pieces (e.g, bone, shell, and sponge), and then further forming carbon nanowires on the carbon black.

The shape of the electrode for a microbial fuel cell of the present invention is not particularly limited, as long as it can function as an electrode. The shape thereof may be appropriately determined depending on the shape and the like of a microbial fuel cell using the electrode. Examples of such a shape include planar, approximately planar, columnar, approximately columnar, spherical, approximately spherical shapes, or combinations thereof. Such a shape of the electrode can be determined by shaping an electrode base as desired, when the electrode base itself is sufficiently stiff for maintaining the shape. Moreover, when an electrode base itself is not sufficiently stiff for maintaining the shape of the electrode, the shape can be determined by shaping a support as desired.

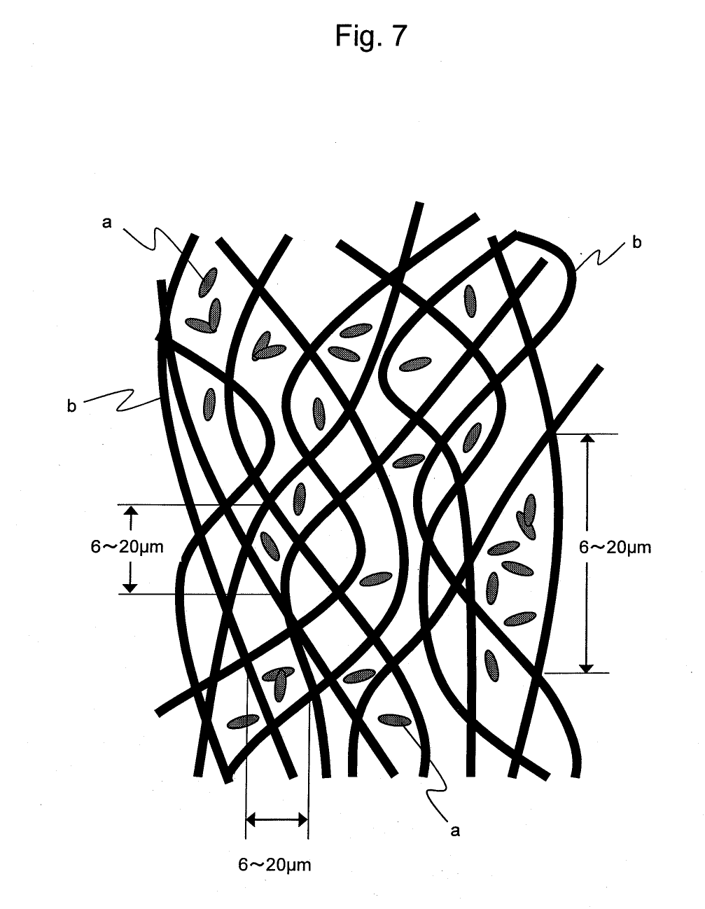

In an embodiment, when the electrode for a microbial fuel cell of the present invention has a fibrous structure or a porous structure, it preferably contains one or more gaps or pores whose size is larger than that of an electron donor microorganism to be used herein. An electron donor microorganism enters gaps or pores of the electrode, so that the rate of electron transfer from the electron donor microorganism or the electron transfer mediator to the electrode can be improved to a level higher than that of smooth-face electrodes. Moreover, the same enables fixation and/or proliferation of the electron donor microorganism within the gaps or the pores. Specifically, in the electrode for a microbial fuel cell of the present invention, the above gaps or pores that are larger in size than the electron donor microorganism increase the surface area for contact between the electrode for a microbial fuel cell and the electron donor microorganism, and fix the electron donor microorganism within the electrode. Thus, a function to retain the contact between the electrode or carbon nanowires and the electron donor microorganism within the electrode can be exhibited. In general, the size of an electron donor microorganism to be used for the electrode for a microbial fuel cell is a diameter ranging from about 0.5 μm to 2 μm in the case of cocci, and the shorter diameter ranging from about 0.2 μm to 1 μm and the longer diameter ranging from about 1 μM to 8 μm in the case of a rod-shaped bacterium such as those of the genus Shewanella, as described later. Therefore, the above gap or pore size is not limited, as long as the microorganisms can easily enter into the gap or pore. For example, when the gap is the gap between fibers of a fibrous structure shown in FIG. 7, the gap size ranges from 6 μM to 20 μm, and preferably from 8 μm to 18 μm in length and width. The pore size may range from 6 μm to 20 μm, and preferably from 8 μm to 18 μm in diameter. In general, when it reaches a size of more than 20 μm, the contact rate with an electron donor microorganism per electrode starts to fall, but the outflow rate of an electron donor microorganism from within the electrode is increased due to the stream, hydraulic pressure, or the like of an electrolytic solution. Such a tendency becomes more significant when the diameter reaches a size of greater than 100 μm. As a result, the electron transfer rate from an electron transfer mediator to the electrode decreases, and fixation of the electron donor microorganism within the electrode becomes difficult. Therefore, a fibrous structure or a porous structure having a major gap or pore size ranging from 6 μm to 20 μm in diameter is desired. In addition, the above electrode may contain, because of its structural characteristics, gaps or pores of sizes greater than 20 μm in diameter or smaller than 6 μm in diameter, which inevitably result from gaps or pores with a diameter between 6 μm and 20 μm.

Furthermore, in an embodiment, the electrode for a microbial fuel cell of the present invention can comprise an electron donor microorganism within the above gaps or pores. The microbial fuel cell carries out electric power generation using an electron donor microorganism as a biocatalyst and biomass such as organic waste water as a fuel. Therefore, the electrode for a microbial fuel cell of the present invention is used by immersing it into biomass such as organic waste water. However, in such biomass, generally, various microorganisms other than the electron donor microorganism are also mixed together. If microorganisms other than the electron donor microorganism, that is, the microorganisms that do not contribute to electron transfer with the electrode, enter and occupy the gaps or pores, the contact rate between the electron donor microorganism and the electrode decreases. As a result, it can decrease the electrical efficiency of the electrode of the present invention. To address such problem, gaps or pores of the electrode of the present invention can be caused in advance to contain an electron donor microorganism so that it occupies the gaps or pores. Such a configuration is convenient when electron transfer between a predetermined electron donor microorganism and an electrode is desired or when biomass containing many microorganisms other than the electron donor microorganism is used as a fuel. Such an electron donor microorganism to be used herein is not limited to be of a single species and may be of multiple species of electron donor microorganisms, as long as they can coexist and do not suppress the electron transfer of each other between each microorganism and the electrode. A method, by which gaps or pores of the electrode contain in advance an electron donor microorganism, is not particularly limited. In general, the electrode of the present invention is immersed in advance into a solution such as a culture solution containing only an electron donor microorganism as a microorganism for a predetermined time, such as 30 minutes to 3 days, 1 hour to 1 day, and 6 hours to 12 hours. Such an electrode is preferably caused to contain water or to keep moisture to avoid drying or the like until use, or is preferably sealed in the case of an anaerobic electron donor microorganism.

In an embodiment, the electrode of the present invention containing the electron donor microorganism may be covered with an enclosure having pores smaller than a microorganism. This can completely eliminate the chance that microorganisms other than an electron donor microorganism would enter through gaps or pores from biomass when the electrode is used. Moreover, this also enables the containment of an electron donor microorganism within the electrode or at the periphery thereof to prevent it from being diffused or discharged outside the electrode. Thus, electric potential can be generated more efficiently. The expression “than a microorganism” means “than microorganisms generally existing within biomass.” Therefore, examples of the microorganism include not only an electron donor microorganism but also other microorganisms. The term “pores smaller than a microorganism” in the Description refers to pores with a size, through which no microorganism can pass but an organic matter that can be a fuel for an electron donor microorganism and a degraded product thereof, as well as an electron transfer mediator such as an electron mediator and a conductive microparticle, can pass. Specifically, the size is 0.45 μm or less, and is preferably 0.2 μm or less, for example. An enclosure is not always required to be stiff, as long as it enables isolation of the electrode of the present invention from microorganisms within biomass. The material of the enclosure is not particularly limited, as long as it has water-resistant and pores of the above size. For example, cellulose acetate, hydrophilic polyvinylidene fluoride, hydrophilic polyether sulfone, or the like to be used for commercially available filter for filter sterilization can be used. The electrode for a microbial fuel cell, which has such a configuration, is particularly effective when electric power generation is performed with only a specific electron donor microorganism using biomass containing various microorganisms or the like as fuels.

Carbon nanowires in the electrode for a microbial fuel cell of the present invention are formed so as to cover the whole or a part of the surface of the electrode base. This structure makes it possible to dramatically increase the surface area compared with a microbial fuel cell using an electrode made of only graphite felt, for example. In general, the performance of an electrode depends on the surface area. Therefore, with the electrode of the present invention, an output value significantly higher than those of conventional electrodes for microbial fuel cells can be obtained.

An electron donor microorganism cannot generally enter gaps and/or pores formed by a nanowire structure. However, in the electrode for a microbial fuel cell of the present invention, it is considered that an electron transfer mediator (described later) enters the gaps and/or pores, so that the surface area increased due to the nanowire structure can be effectively used. Therefore, even if an electron donor microorganism cannot enter, electrons can be efficiently recovered by the electrode of the present invention.

The electrode generally functions as an anode (negative electrode, or minus electrode) when used for a microbial fuel cell, but can also be used as a cathode (positive electrode, or plus electrode).

### 1-4. Other Applications of Electrode for Microbial Fuel Cell

The electrode for a microbial fuel cell of the present invention can be used not only for a microbial fuel cell, but also for, because of its configuration, other applications to which the electrode of the present invention is applicable other than a microbial fuel cell.

The electrode for a microbial fuel cell of the present invention is characterized by drastically increasing the surface area with carbon nanowires compared with conventional electrodes to enhance direct or indirect electron transfer efficiency with an electron transfer microorganism, resulting in a dramatic increase in the thus generated electric potential.

Therefore, the electrode of the present invention can be similarly used in other fields to which the principle is applicable. Examples of applications include an electrode for a microbial solar cell, a microbial electrolysis cell, and a biosensor.

A microbial solar cell is a cell for generating electric power by transferring electrons generated when photosynthetic bacteria such as cyanobacteria carry out photosynthesis to an electrode, as described in the above JP Patent Publication (Kokai) No. 2007-324005. The electrode is used for such a microbial solar cell.

The microbial electrolysis cell is an apparatus having a configuration similar to that of a microbial fuel cell, by which hydrogen is generated from proton using electric current generated by a microorganism from an organic matter and a low-potential electrode. Here, the term “biosensor” as used herein refers to a detector using a microorganism, which has a configuration similar to that of a microbial fuel cell. An example thereof is a BOD sensor.

### 1-5. Preparation of Electrode for Microbial Fuel Cell

The electrode for a microbial fuel cell of the present invention can be prepared using all methods known in the art for forming carbon nanowires on a conductive base as described above. Hereinafter, a specific method for preparing the electrode for a microbial fuel cell of the present invention is as explained below with an example thereof.

### (1) Preparation of Electrode Base

An electrode base is prepared to have a size and/or a shape as necessary when the base itself is sufficiently stiff as a support. For example, when graphite felt is used as an electrode base, commercially available graphite felt with an appropriate thickness may be cut to a size or a shape as desired according to the shape of the microbial fuel cell. Moreover, when an electrode base is formed on another support, for example, an appropriate support such as glass fiber is prepared into a size and/or a shape as necessary, and then carbon black as an electrode base may be formed on the support by techniques known in the art, such as coating, deposition, and the like. Alternatively, a commercially available electrode base having such a configuration can also be used herein.

In addition, carbon is hydrophobic. Hence, for example, when carbon fiber such as the above graphite felt is used as an electrode base, the surface is preferably hydrophilized in advance under appropriate conditions. Methods known in the art may be used for hydrophilization. As described in Example 1, an example thereof is a method that involves overnight immersion in about 36 N sulfuric acid. An electrode base hydrophilized by surface treatment with sulfuric acid is then immersed in an ethanol/water mixture containing polyvinyl alcohol and nickel nitrate hexahydrate ((Ni(NO₃)₃.6H₂O), for example. After drying, a nickel catalyst layer consisting of oxidized nickel (NiO) particles is formed on the surface of the electrode base by sintering, thereby removing organic matter on the surface of the electrode base. Subsequently, treatment for reducing oxidized nickel particles using a mixed gas of hydrogen (H₂) and nitrogen (N₂), so that surface treatment of the electrode base can be achieved.

### (2) Formation of Carbon Nanowire

A method for forming carbon nanowires on an electrode base is not particularly limited, and a method known in the art can be used. An example thereof is a method that involves directly synthesizing carbon nanowires on the surface of an electrode base. A specific example thereof is a method for synthesizing carbon nanowires on the surface of an electrode base, the surface of which has been appropriately treated in advance within a high-temperature furnace through which a mixed gas comprising ethylene (C₂H₄), hydrogen, and nitrogen is caused to pass.

### (3) Washing

After formation of carbon nanowires on the surface of the electrode base, impurities are removed by washing several times with ethanol or the like (e.g., three or more times of washing).

### 2. Microbial Fuel Cell

### 2-1. Summary and Definition

A 2^{nd} embodiment of the present invention is a microbial fuel cell using any one of the electrodes for microbial fuel cells of the present invention.

The term “microbial fuel cell” refers to an apparatus for generating electric power by acquiring or extracting electrons generated through metabolism such as respiration of an electron donor microorganism as a biocatalyst as described above, and then transferring electrons to an electrode.

The term “electron donor microorganism” refers to a microorganism capable of transferring electrons generated by metabolism directly (e.g., by contact between an electron carrier existing in cell membrane and an electrode) or indirectly (e.g., by an electron transfer mediator) to the electrode for a microbial fuel cell of the present invention.

Here, the term “electron transfer mediator” refers to an electron transporter capable of transporting electrons from a microorganism to an electrode, such as (1) a redox mediator compound, (2) an electron mediator and/or (3) a conductive fine particle.

(1) The term “redox mediator compound” refers to an electron shuttle compound, which is mainly produced within an electron donor microorganism, is released extracellularly, and is capable of transporting electrons generated through microbial metabolism (resulting from the mediator compound's own oxidation and reduction while shuttling between the microorganism and the electrode) to the electrode. Examples of such a mediator compound include phenazine-1-carboxamide, pyocyanin, and 2-amino-3-carboxy-1,4-naphthoquinone (ACNQ).
(2) The term “electron mediator” refers to a redox compound that is artificially synthesized having functions similar to those of the redox mediator compound. Examples of such electron mediator include neutral red, safranine, phenazine ethosulfate, thionine, methylene blue, toluidine blue-O, phenothiazine, resorufin, gallocyanine, 2-hydroxy-1,4-naphthoquinone (HNQ), and porphyrin.
(3) The term “conductive fine particles” refers to microparticles made of metal or semiconductor, which are capable of binding to an electron donor microorganism, extracting electrons from the microorganism, and then transferring the electrons to an electrode. Examples of such conductive fine particles include iron oxide, iron sulfide, and manganese oxide.

The type of an electron donor microorganism to be used in the microbial fuel cell of the present invention is not particularly limited, as long as it is a microorganism capable of transferring electrons to the electrode for a microbial fuel cell of the present invention. A preferable example thereof is a microorganism capable of transferring electrons extracellularly. The term “capable of transferring electrons extracellularly” refers to capacity for acquiring energy required for biological activity as a result of a series of oxidation and reduction of electron carriers, and to transfer the thus generated electrons to electron carriers existing in cell membrane (e.g., membrane-bound cytochrome) (Lovley D. R.; Nat. Rev. Microbiol., 2006, 4, 497-508). A microorganism having such capacity is preferred since: it can easily transfer electrons retained by electron carriers on cell membrane through direct contact between the electron carriers and the electrode; and a mediator such as a redox mediator compound can easily extract electrons from the microorganism. Examples of an electron donor microorganism capable of transferring electrons extracellularly include catabolic metal-reducing bacteria such as the genus Shewanella and the genus Geobacter, and bacteria of the genus Pseudomonas, or the bacteria of the genus Rhodoferax. Specific examples of bacteria of the genus Shewanella include S. loihica, S. oneidensis, S. putrefaciens, and Shewanella algae. Specific examples of bacteria of the genus Geobacter include G. sulfurreducens and G. metallireducens. Specific examples of bacteria of the genus Pseudomonas include P. aeruginosa. Specific examples of bacteria of the genus Rhodoferax include R. ferrireducens. Moreover, an electron donor microorganism capable of producing a redox mediator compound and releasing the mediator compound extracellularly is particularly preferred in the present invention. This is because such a redox mediator compound directly carries out electron transfer with carbon nanowires described later, so that the effects of the present invention can be exhibited more efficiently. Examples of an electron donor microorganism capable of producing and/or releasing a redox mediator compound include bacteria of the genus Shewanella, bacteria of the genus Pseudomonas, and bacteria of the genus Rhodoferax. An electron transfer microorganism may be either a wild-type or a mutant. For example, a mutant electron donor microorganism capable of releasing even more electrons extracellularly and/or a mutant electron donor microorganism capable of generating and/or releasing a redox mediator compound at even a higher level, which are prepared by genetic engineering, meet the purpose of the present invention and thus are more preferable.

### 2-2. Configuration of Microbial Fuel Cell

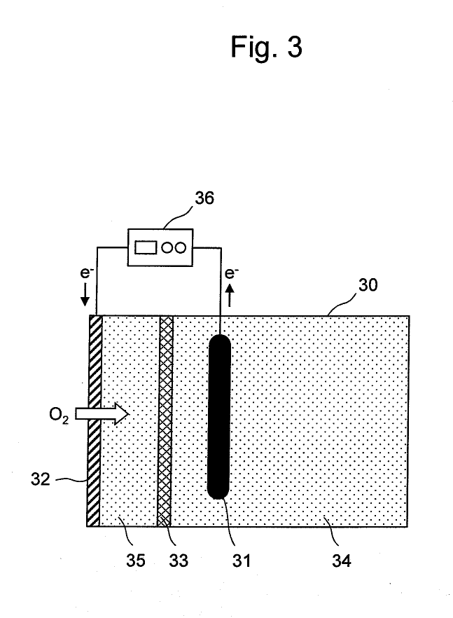

The configuration of the microbial fuel cell of the present invention is explained with reference to a conceptual diagram of the microbial fuel cell of the present invention shown in FIG. 3. The microbial fuel cell shown in FIG. 3 comprises a pair of electrodes (31 and 32), a barrier (33), an electrolytic vessel (30) accommodating electrolyte solutions (34 and 35), and an external circuit (e.g., data logger) (36) electrically connected to the pair of electrodes. However, the configuration of the microbial fuel cell of the present invention is not limited thereto, but examples thereof include all known microbial fuel cells for which the electrode for a microbial fuel cell of the present invention can be used.

### 2-2-1. Electrode

The microbial fuel cell of the present invention is provided with a pair of an anode (31) and a cathode (32), as an electrode.

As an anode, the electrode for a microbial fuel cell of the 1^{st} embodiment of the present invention above is used. At least one surface of such an anode should be in direct contact with an electrolyte solution in an anode vessel described later. In general, an anode is immersed in an electrolyte solution in an electrolytic vessel and used.

A cathode to be used herein is not particularly limited and may be any cathode as long as it contains an electric conductor such as carbon or metal. FIG. 3 shows a case in which an air cathode (air positive electrode) that is exposed to air is used. An air cathode to be preferably used herein has gas (in particular, oxygen) permeability. Examples of such an air cathode include carbon paper, carbon cloth, and 4-polytetrafluoroethylene (PTFE) carrying platinum particles.

### 2-2-2. Barrier

A barrier (33) is configured to separate the above pair of electrodes from each other within an electrolytic vessel. The material of such a barrier is not particularly limited, as long as it enables selective permeation of cations. An example thereof is proton (H⁺) exchange membrane (PEM). The proton exchange membrane is a proton-conductive ion-exchange polymer electrolyte. Examples thereof include a perfluorosulfonate-based fluorine ion exchange resin, and an organic/inorganic complex compound. Examples of the above perfluorosulfonate-based fluorine ion exchange resin include copolymers containing a polymer unit based on perfluorovinylether that has a sulfonic group (—SO₃H) and/or a carboxyl group (—COOH), and a polymer unit based on tetrafluoroethylene. A specific example thereof is Nafion (Registered trademark: Du Pont). Furthermore, the organic/inorganic composite compound is a substance comprising a compound prepared via conjugation of a hydrocarbon-based polymer (e.g., mainly comprising polyvinyl alcohol) with an inorganic compound (e.g., tungstic acid). They are known membranes and many membranes are marketed such as Nafion, and thus can also be used herein.

Also, when a cathode is exposed to air, a cathode (air cathode) may be bound to a barrier for integration. Such an integral-type cathode/barrier can be used in a single vessel type microbial fuel cell.

In addition, a barrier (33) is not an essential component in the microbial fuel cell of the present invention. However, when the practicality of a cell, such as the life of an electrode, is taken into consideration, a barrier is desirably provided.

### 2-2-3. Electrolyte Solution

An electrolyte solution (34) is a solution containing an electrolyte. An electrolyte to be used in the microbial fuel cell of the present invention is not particularly limited, as long as it is a substance that can be electrolytically dissociated in water. Moreover, not only an electrolyte of a single type, but also a mixture of multiple electrolytes can also be used herein. Specific examples of such an electrolyte include K₂HPO₄, KH₂PO₄, NaCO₃, and NaHCO₃.

### 2-2-4. Electrolytic Vessel

An electrolytic vessel configures the main part of the microbial fuel cell of the present invention. As electrolytic vessels, a double vessel-type vessel, in which an anode vessel is separated from a cathode vessel by a barrier, and a single-vessel-type vessel having a configuration, in which an air cathode is integrated with a barrier and thus is composed only of an anode vessel, are known. All of these types may be used for the microbial fuel cell of the present invention.

In the case of such a double vessel type, all or some anodes in an anode vessel or all or some cathodes in a cathode vessel are each arranged so that they are brought into direct contact with the electrolyte solution. An anode vessel as a fuel vessel contains, in addition to the electrolyte solution, an electron donor microorganism, a fuel and an electron donor, and if necessary an electron transfer mediator such as an electron mediator and a conductive fine particle.

Electron donor microorganisms to be used in an anode vessel may be either of a single species or multiple species. A mixed system comprising electron donor microorganisms of multiple species is advantageous in that, when organic waste water, sludge, or the like is used as a fuel, electron donor microorganisms originally inhabiting therein can be directly used without adding electron donor microorganisms from outside. For example, Pseudomonas aeruginosa and Geobacter inhabit everywhere in natural environment such as soil, fresh water, and seawater. In general, if sludge or the like is used as a fuel, the electron donor microorganism can be used without adding any electron donor microorganism from outside. Further, as described above, Pseudomonas aeruginosa can produce a redox mediator compound, so that it is very useful as an electron donor microorganism in the present invention.

On the other hand, a cathode vessel as an air layer is configured so that it can supply air containing oxygen.

A fuel is a nutritional substrate required for keeping and/or growing an electron donor microorganism. Such a nutritional substrate is not particularly limited, as long as it is a substance that can be metabolized by the microorganism. For example, useful resources including alcohols such as methanol and ethanol, monosaccharides such as glucose, and polysaccharides such as starch, amylose, amylopectin, glycogen, cellulose, maltose, sucrose, and lactose, as well as unused resources (that is, organic waste) including agricultural waste, organic waste water, excrements, sludge, and food residues can be used. Furthermore, examples of a fuel include substances that can function as electron donors for electron donor microorganisms (e.g., lactic acid). A fuel can be added if necessary in order to keep and grow electron donor microorganisms in an anode vessel and/or to supply an electron donor.

An electron transfer mediator may be added to an electrolytic vessel as necessary. If at least one type of electron donor microorganism to be contained herein is capable of producing and releasing a redox mediator compound, addition of an electron transfer mediator is not always required. In contrast, if all electron donor microorganisms are of types incapable of producing and releasing a redox mediator compound, addition of an electron transfer mediator is essential.

### EXAMPLES

### Example 1

### Preparation of Electrode for Microbial Fuel Cell

In this example, preparation of a graphite felt-carbon nanowire electrode (A), a graphite plate-carbon nanowire electrode (B), and a graphite felt-polyaniline nanowire electrode (C), each of which is an electrode for a microbial fuel cell of the present invention comprising an electrode base and nanowires (herein, referred to as “[electrode base type]-[electrically conductive substance type]-nanowire electrode” as mentioned above) made of an electrically conductive substance are formed across the whole or a part of the surface of the electrode base, is described.

### A. Preparation of Graphite Felt-Carbon Nanowire Electrode

### (1) Preparation of Graphite Felt (Hereinafter, Also Referred to as “GF”)

GF (Sogo carbon Co., Ltd., 3 mm in thickness) was cut to a size of 1 cm², and then immersed in 36N sulfuric acid at room temperature for 1 day to enhance the hydrophilicity of the surface. The resultant was immersed in a water/ethanol (1:1) mixture containing 25 g/L (w/v) polyvinyl alcohol and 50 g/L nickel nitrate hexahydrate (Ni(NO₃)₃.6H₂O) and then dried in an oven at 120° C. for 10 minutes. Subsequently, the resultant was sintered at 400° C. for 2 hours to form a thin film layer comprising nickel oxide (NiO) particles on the GF surface, thereby removing organic matter existing on the GF surface. Subsequently, a mixed gas of 20% hydrogen (H₂) and 80% nitrogen (N₂) (v/v) was used at a total flow of 100 sccm, so as to reduce nickel oxide particles.

### (2) Formation of Carbon Nanowires (Hereinafter, Also Referred to as “CN”) on GF Surface

Carbon nanowires were directly formed on the GF surface by a CVD (chemical vapor deposition) method. First, GF, the surface of which had been pre-treated in (1) above, was incubated using a nickel catalyst for 4 hours in a tubular quartz furnace at 750° C., through which a mixed gas of 20% ethylene (C₂H₄), 20% hydrogen, and 60% nitrogen was caused to continuously pass. Carbon nanowires were directly synthesized on the GF surface. After synthesis, carbon nanowires were washed with ethanol and then stored in distilled water until the use thereof for the experiment. Thus, the resultant was designated as the electrode for a microbial fuel cell (GF-CN electrode) of the present invention comprising graphite felt-carbon nanowires.

### B. Preparation of Graphite Plate-Polyaniline Nanowire Electrode

### (1) Preparation of Graphite Plate (Hereinafter, Also Referred to as “GP”)

GP (KOKUGO Co., Ltd.) (3 cm²) having the polished surface was prepared by the same method as in “(1) Preparation of graphite felt” of “A. Preparation of graphite felt-carbon nanowire electrode”.

### (2) Formation of Carbon Nanowires on GP Surface

An electrode was prepared by the same method as in (2) “Formation of carbon nanowires on GF surface” of A “Preparation of graphite felt-carbon nanowire electrode” above. The thus obtained electrode was designated as the electrode for a microbial fuel cell (GP-CN electrode) of the present invention, comprising graphite plate-carbon nanowires.

### C. Preparation of Graphite Felt-Polyaniline Nanowire Electrode

### (1) Preparation of Graphite Felt

Graphite felt was prepared by the same method as in (1) “Preparation of graphite felt” of A “Preparation of graphite felt-carbon nanowire electrode” above.

### (2) Formation of Polyaniline Nanowires (Hereinafter, Also Referred to As “PAN”) on GF Surface

A monomer solution used as an electrolytic solution was a 1M sulfuric acid solution containing a 0.2 M aniline monomer (Wako Pure Chemical Industries, Ltd.).

One end of a titanium wire as a conductor was connected to one end of the GF prepared in (1), so as to work as a working electrode. The other end of the conductor was connected to a potentiostat (HZ-5000, HOKUTO DENKO CORPORATION). Furthermore, each one end of a reference electrode (Ag/AgCl electrode immersed in a saturated KCl solution) and a counter electrode (platinum) was connected to the above potentiostat. These electrodes were immersed in the above monomer solution. Subsequently, the potential of the working electrode was set between −0.5V and 1.3V with respect to the reference electrode, and then PAN was electrodeposited on the GF surface with an electrode scanning rate of 50 mV/second and 10 reciprocations of scanning.

GF on which PAN had been electrodeposited was removed from the potentiostat, washed 3 times with distilled water, and then dried. The GF was designated as the electrode for a microbial fuel cell (GF-PAN electrode) of the present invention comprising graphite felt-polyaniline nanowires.

### Example 2

### Verification of the Electric Power Generation Capacity of Electrode for Microbial Fuel Cell of the Present Invention

The capacity of the electrode for a microbial fuel cell of the present invention for generating electric power was verified using an electrochemical cell with a potentiostat system.

### 1. Electrode

Working electrodes as anodes were used in the following combination.

The GP-CN electrode prepared in Example 1 and an electrode (GP electrode) comprising only GP as a control electrode were used. As the GP electrode, the electrode prepared in (1) “Preparation of graphite plate” of B “Preparation of graphite plate-carbon nanowire electrode” in Example 1 was used. All electrode sizes were the same.

A platinum electrode and an Ag/AgCl (saturated KCl) electrode were used as a counter electrode and a reference electrode, respectively.

### 2. Electron Donor Microorganism

As an electron donor microorganism, Shewanella loihica PV-4 strain (American type culture collection: ATCC No. BAA-1088; 2008) was used.

S. loihica PV-4 was inoculated in advance in 5 mL of LB medium (Difco), and then aerobically cultured at 30° C. overnight. The culture solution was centrifuged to collect cells, it was suspended in 1 mL of DM medium (Difined Media). The suspension was added to an electrolytic vessel. The composition of the DM medium is as follows: 2.5 g/L NaHCO₃; 008 g/L CaCl₂.2H₂O; 1.0 g/L NH₄Cl; 0.2 g/L MgCl₂.6H₂O; 10 g/L NaCl; and 7.2 g/L HEPES. Furthermore, 20 mM sodium lactate (Wako Pure Chemical Industries, Ltd.) was added as an electron donor for S. loihica PV-4 and at the time of main culture, a 0.5 g/L yeast extract (Wako Pure Chemical Industries, Ltd.) was added to supply micronutrients required for the growth of S. loihica PV-4.

### 3. Preparation of Potentiostat System

A potentiostat system used in the example was prepared as follows. First, a working electrode as an anode is placed on the bottom of an electrolytic vessel, 5 mL of DM-L medium was added into the vessel, and then the resultant was purged with pure nitrogen for 10 minutes. After a counter electrode and a reference electrode were placed in the vessel, the above pre-culture solution containing about 2×10⁸ S. loihica PV-4 cells was added to the electrolytic vessel prepared by applying constant voltage of 0.2V to the reference electrode (Ag/AgCl electrode) using a potentiostat (HSV-100, HOKUTO DENKO CORPORATION).

### (Results)

The results are shown in FIG. 1(B). FIG. 1(B) shows changes over time in the generated current density obtained from S. loihica PV-4 when the GP-CN electrode or the GP electrode was used as an anode.

When the GP electrode had been used, the electric current gradually increased after introduction of S. loihica PV-4 (0 hour) and then reached a constant level of about 10 μA/cm² after 30 hours. Meanwhile, when the GP-CN electrode as the electrode for a microbial fuel cell of the present invention had been used, about 15 hours after introduction of S. loihica PV-4, very large electric current reaching a maximum of about 150 μA/cm² was obtained. Subsequently, electric current decreased with depletion of lactic acid. However, the GP-CN electrode immediately recovered after 20 mM lactic acid as an electron donor had been added several times to the electrolytic vessel (white arrows in FIG. 1(B)), and thus the electric current finally reached the highest level of 270 μA/cm². On the other hand, the GP electrode recovered after addition of lactic acid; however, an increase in electric current of about 10 μA/cm² was not observed.

The above results revealed that the electrode for a microbial fuel cell of the present invention, wherein carbon nanowires are formed on the surface of a graphite plate, has extremely high capacity for generating electric power as an electrode for a microbial fuel cell, compared with conventional electrodes for biofuel cells, because of its high affinity for electron donor microorganisms and the resulting high electron recovery efficiency.

### Example 3

### Verification of Electric Power Generation Capacity of Electrode for Microbial Fuel Cell of the Present Invention Having Fibrous Structure

The electric power generation capacity of the electrode for a microbial fuel cell of the present invention, which has a fibrous structure, was verified using a microbial fuel cell containing no electron mediator and no conductive fine particles.

### 1. Electrode

As anodes, the GF-CN electrode prepared in Example 1 and its counter electrode, a GF electrode, were used. All electrode sizes were the same 1 cm².

As a cathode, an air cathode was used. The air cathode comprises 4-polytetrafluoroethylene (PTFE) carrying 8 mg/cm² platinum particles (Sigma).

### 2. Preparation of Electron Donor Microorganism

As an electron donor microorganism, a microorganism in the soil collected from a paddy field in Kamaishi city in Japan was used.

### 3. Preparation of Electrolytic Vessel

An electrolytic vessel used in this example comprises a single-vessel-type electrolytic vessel having no barrier (33) in the microbial fuel cell of the present invention as shown in FIG. 3. Furthermore, the vessel accommodated the electron donor microorganism and an electrolyte solution supplemented with a nutritional substrate. Specifically, 12 mL of buffer solution containing 200 mM K₂HPO₄/KH₂PO₄ (pH 6.8) was added as an electrolyte solution to the 15-mL electrolytic vessel. Furthermore, as a nutritional substrate, a mixed organic substrate prepared by mixing starch, peptone, and fish meal at 3:1:1 (289 g of COD/L, COD=chemical oxygen demand) was used. The mixed organic substrate was a biomass model to be used for the microbial fuel cell of the present invention. The mixed organic substrate was added in an amount ranging from 0.2 mL to 0.4 mL per day to the electrolytic vessel. Subsequently, the medium was purged for 5 minutes with nitrogen. 500 mg (wet weight) of the soil of the paddy field was added to the electrolytic vessel, followed by anaerobic culture at 30° C. Then the mixed organic substrate (300 g of COD/L) was added in an amount of 0.2 mL per day to the electrolytic vessel.

To obtain a current-voltage (IV) curve and an output curve, electric current was measured with various levels of total voltage using a potentiostat (HA-1510, HOKUTO DENKO CORPORATION).

### (Results)

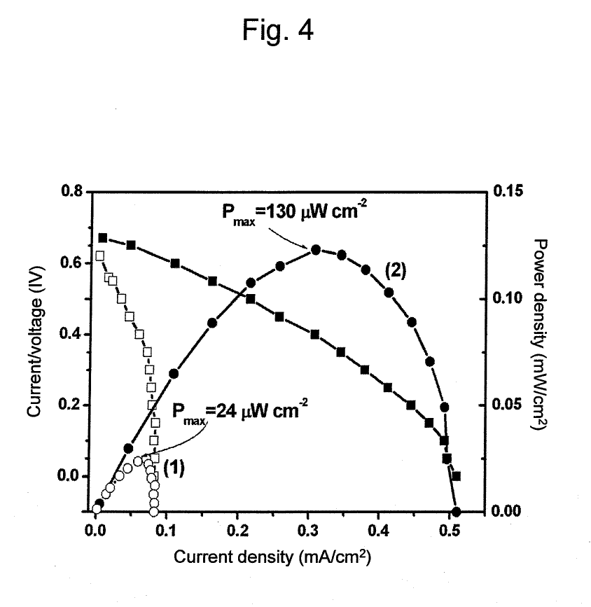

FIG. 4 shows the results. FIG. 4 shows the IV and output of the microbial fuel cell when each anode was used. When the GF electrode was used as an anode, short-circuit current density (◯) of 0.08 mA/cm² and power density (□) of Pₘₐₓ=24 μW/cm² were obtained. On the other hand, when the GF-CN electrode was used as an anode, short-circuit current density () of 0.51 mA/cm² and power density (▪) of Pₘₐₓ=130 μW/cm² were obtained separately. That is, it was revealed that coating of the GF surface with CN improves the output by 5 or more times over the original level.

It was revealed by the results of Examples 2 and 3 that when carbon nanowires are formed on the surface of a GP or GF electrode, the electrode for a microbial fuel cell becomes capable of recovering electrons extremely efficiently in the microbial fuel cell.

The microbial fuel cell of this example was composed of a system very similar to that of microbial fuel cells to be used during the stage of practical application. For example, the electron donor microorganism used herein had been contained in the soil of the paddy field and had not been identified. Furthermore, the soil also contained many other microorganisms incapable of functioning as electron donor microorganisms of the present invention. That is, this system demonstrates that the microbial fuel cell of the present invention can sufficiently exhibit the effects of the present invention when the direct use of: sludge, organic waste water, or the like to be used as a fuel in an actual microbial fuel cell; that is, an electron donor microorganism widely existing in such fuel, without the necessity of adding an electron donor microorganism from outside.

### Example 4

### Verification of Electric Power Generation Capacity of Electrode for Microbial Fuel Cell of the Present Invention Having Electron Mediator

The electric power generation capacity of the electrode for a microbial fuel cell of the present invention; that is, in a microbial fuel cell containing an electron mediator, was verified.

A method in this example was performed principally according to the method of Example 3. The basic configuration of an electrode, an electron donor microorganism, and an electrolytic vessel employed herein was the same as that of Example 3.

This example is characterized by the further addition of 0.5 mM HNQ (2-hydroxy-1,4-naphthoquinone) to an electrolytic vessel. HQN is a typical artificial electron mediator compound to be used for enhancing electric current in a microbial fuel cell.

### (Results)

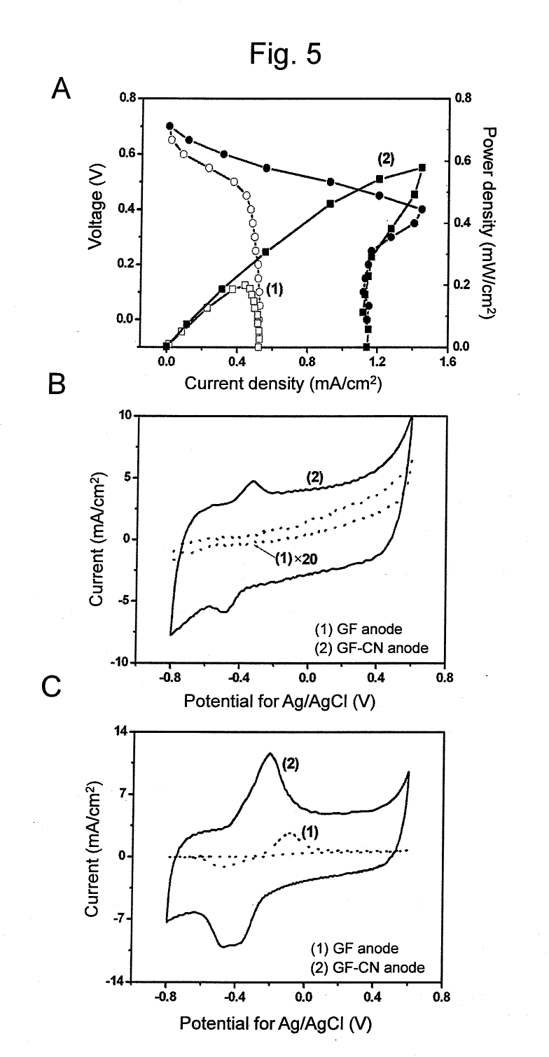

FIG. 5(A) shows the results. FIG. 5(A) shows the IV and output of a microbial fuel cell when each anode was used. In the case of a microbial fuel cell having HQN, Pₘₐₓ() reached 600 μW/cm² when a GF-CN electrode was used as an anode. That is, it was revealed that the addition of an electron mediator to the microbial fuel cell of Example 3 using a GF-CN electrode as the electrode for the microbial fuel cell of the present invention improves the output 4.5 or more times over the microbial fuel cell of Example 3 having no electron mediator.

### Example 5

### Cyclic Voltammogram of Each Electrode for Microbial Fuel Cell

Cyclic voltammogram was measured for the microbial fuel cell using each anode of Example 4, so as to examine electron transfer property in the presence of a mixture of microorganisms. Cyclic voltammogram involves continuously changing the potential of a working electrode with respect to a reference electrode in an electrochemical cell, so as to measure the resulting electric current passed. The redox potential of the reaction system can be found on the basis of the midpoint potential of the two peaks (+ and −).

### (Results)

FIGS. 5(B) and (C) show the results. FIG. 5(B) shows the result of cyclic voltammogram for the microbial fuel cell of Example 4 (substantially the microbial fuel cell of Example 3 before addition of HQN to the electrolytic vessel). FIG. 5(C) shows the result of cyclic voltammogram for the microbial fuel cell after addition of HQN to the electrolytic vessel. In FIGS. 5(B) and (C), broken line (1) indicates the result of cyclic voltammogram for the GF electrode and continuous line (2) indicates the result of cyclic voltammogram for the GF-CN electrode.

In these figures, the peak representing redox species in the electrolytic solution was higher in the case of using the GF-CN electrode than the case of using the GF electrode. This is because the amount of redox species involved in electron transfer was increased, indicating the dominance of the GF-CN electrode as an electrode.

### Example 6

### Comparison of Electric Power Generation Capacity Between the Electrode for a Microbial Fuel Cell of the Present Invention and a Conventional Electrode for a Microbial Fuel Cell

With the use of microbial fuel cells having no electron mediator and no conductive fine particles, the electric power generation capacity was compared between the electrode for a microbial fuel cell of the present invention and the conventional electrode for a microbial fuel cell.

### (Methods)

Except for the use of a GF-PAN electrode in addition to the GF-CN electrode prepared in Example 1 and a control electrode thereof (GF electrode) as anodes, the configuration of a cathode, an electron donor microorganism, and an electrolytic vessel and a method employed herein were the same as those of Example 3.

### (Results)

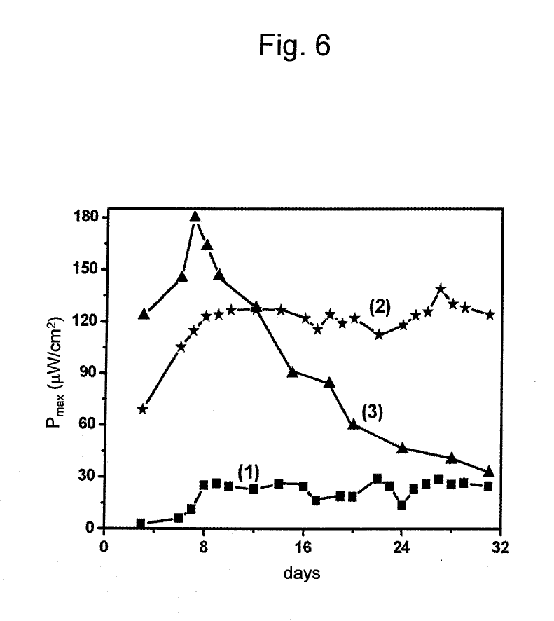

FIG. 6 shows the results. Curve (1) with ▪ plots shows changes over time in Pₘₐₓ for the GF electrode, curve (2) with * plots shows the same for the GF-CN electrode, and curve (3) with ▴ plots shows the same for the GF-PAN electrode. P for the GF electrode was max relatively stabilized at about 30 μW/cm². The Pₘₐₓ for the GF-PAN electrode reached a high level of about 180 μW/cm² after 7 days, but rapidly decreased to almost the same level as that of the GF electrode after 31 days. On the other hand, the Pₘₐₓ for the GF-CN electrode reached the level of about 120 μW/cm² after 10 days although it did not reached the maximum Pₘₐₓ of the GF-PAN electrode, and then it was relatively stabilized at about 120 μW/cm². It was revealed by the results that the GF-CN electrode having the configuration of the present invention has very stable electric power generation capacity in the presence of groups of natural microorganisms exhibiting various catabolic activities.

All publications, patents, and patent applications cited herein are incorporated herein by reference in their entirety.

1. An electrode for microbial fuel cell, comprising an electrode based that comprises carbon and carbon nanowires that are formed across the whole or a part of the surface of the electrode base, wherein the electrode for a microbial fuel cell has a fibrous structure or a porous structure containing gaps and/or pores, and the length and/or the width of a single gap and the diameter of a single pore each range from 6 μm to 20 μm.

2. The electrode according to claim 1, wherein all or some carbon nanowires form a nanowire network.

3. The electrode according to claim 2, wherein the electrode base comprises graphite.

4. The electrode according to any one of claim 3, wherein the gap or the pore contains an electron donor microorganism therein.

5. A microbial fuel cell, using the electrode of any one of claim 4.

6. The microbial fuel cell according to claim 5, comprising an anode and/or a cathode, an electrolyte solution, and an electrolytic vessel accommodating them, wherein the electrolyte solution in the electrolytic vessel further comprises an electron donor microorganism comprising a single or multiple species and a nutritional substrate required for the metabolism of the microorganism.

7. The microbial fuel cell according to claim 6, wherein the cathode is an air cathode having gas permeability and the electrolytic vessel has a single vessel structure composed of only an anode vessel.

8. The microbial fuel cell according to claim 7, wherein the vessel in which the anode or the cathode is installed further comprises a redox mediator compound, an electron mediator, and/or conductive fine particles therein.
